(19) United States
(12) Patent Application Publication
(10) Pub. No.: US 2025/0392041 A1
(43) Pub. Date: Dec. 25, 2025

(54) Method and Apparatus for Determining Apparent Elevation Angle

(71) Applicant: Korea Aerospace Research Institute, Daejeon (KR)

(72) Inventors: Seokkwon KIM, Daejeon (KR); Sung-Wan KIM, Daejeon (KR)

(21) Appl. No.: 18/950,467

(22) Filed: Nov. 18, 2024

(30) Foreign Application Priority Data
Jun. 19, 2024 (KR) 10-2024-0079739

(51) Int. Cl. H01Q 3/06; G01C 1/00

(52) U.S. Cl. CPC H01Q 3/06; G01C 1/00

(57) ABSTRACT

An apparatus for determining an apparent elevation angle, according to an example embodiment, includes a processor configured to: determine a distance between a ground station and an altitude of a flight vehicle and a true elevation angle corresponding to a direction from the ground station toward the flight vehicle; determine a maximum elevation angle error, using the true elevation angle and a direction toward a position at which a radio wave transmitted by the ground station at the true elevation angle is propagated to the same altitude as the flight vehicle based on refractive indices of altitudes between the ground station and the flight vehicle; determine an apparent elevation angle range relative to the true elevation angle, based on the maximum elevation angle error; update the apparent elevation angle range by comparing the true elevation angle and an elevation angle estimated from a median elevation angle of the apparent elevation angle range based on the refractive indices of the altitudes between the ground station and the flight vehicle; and determine an apparent elevation angle, in response to the apparent elevation angle range being within a tolerance.

### RELATED APPLICATION DATA

This application is based on and claims priority under 35 U.S.C. § 119 (a) to Korean Patent Application No. 10-2024-0079739 filed on Jun. 19, 2024, in the Korean Intellectual Property Office, the disclosure of which is incorporated by reference herein in its entirety.

### FIELD OF DISCLOSURE

The following embodiments relate to a technology for determining an apparent elevation angle from a true elevation angle and distance between a flight vehicle and a ground station.

### BACKGROUND

Radio waves traveling between a ground station and a flight vehicle (e.g., a communication satellite) are affected by refraction, reflection, attenuation, delay, and the like in the atmosphere of the Earth. Therefore, for communication between the ground station and the flight vehicle (i.e., to determine a direction in which an antenna of the ground station is required to be oriented to transmit radio waves to the flight vehicle), the effect of the atmosphere on the radio waves may need to be considered. To this end, various techniques have been proposed to estimate the refraction, reflection, attenuation, delay, and the like of the atmosphere with respect to radio waves.

For example, among methods of estimating a refractive index of the atmosphere, a method using a radiosonde may measure meteorological information including temperature, barometric pressure, and relative humidity by floating a radiosonde at a specific altitude and estimate a refractive index of the atmosphere at the specific altitude based on the measured meteorological information. Although the method using a radiosonde to estimate a refractive index of the atmosphere may more accurately estimate a refractive index, it may consume greater costs for maintenance, repair, and operation. Therefore, to estimate a refractive index of the atmosphere more economically, models designed to estimate refractive indices of the atmosphere at various altitudes using only meteorological information on the ground have been proposed.

### SUMMARY OF THE DISCLOSURE

According to an example embodiment, there is provided a method of determining an apparent elevation angle, the method including: determining a distance between a ground station and a flight vehicle and a true elevation angle corresponding to a direction from the ground station toward the flight vehicle; determining a maximum elevation angle error; determining an apparent elevation angle range relative to the true elevation angle, based on the maximum elevation angle error; updating the apparent elevation angle range by comparing the true elevation angle and an elevation angle estimated from a median elevation angle of the apparent elevation angle range based on refractive indices of altitudes between the ground station and the flight vehicle; and determining the apparent elevation angle, in response to the apparent elevation angle range being within a tolerance.

The updating of the apparent elevation angle range may include changing the apparent elevation angle range to one of a first angle range and a second angle range, relative to the median elevation angle of the apparent elevation angle range, based on a result of comparing the true elevation angle and the elevation angle estimated from the median elevation angle of the apparent elevation angle range.

The changing of the apparent elevation angle range may include determining the apparent elevation angle range to be the first angle range in response to the elevation angle estimated from the median elevation angle of the apparent elevation angle range being less than the true elevation angle, and determining the apparent elevation angle range to be the second angle range in response to the elevation angle estimated from the median elevation angle of the apparent elevation angle range being greater than the true elevation angle.

The first angle range may be higher than the second angle range.

The updating of the apparent elevation angle range may include determining the apparent elevation angle to be the median elevation angle of the apparent elevation angle range, in response to the elevation angle estimated from the median elevation angle of the apparent elevation angle range being equal to the true elevation angle.

The updating of the apparent elevation angle range may include repeatedly updating the apparent elevation angle range while the apparent elevation angle range is out of the tolerance.

The method may further include orienting an antenna of the ground station toward the determined apparent elevation angle.

The determining of the maximum elevation angle error may include determining the maximum elevation angle error, using the true elevation angle and a direction toward a position at which a radio wave transmitted by the ground station at the true elevation angle is propagated to the same altitude as the flight vehicle based on the refractive indices of the altitudes between the ground station and the flight vehicle.

The determining of the maximum elevation angle error may include determining a constant of Snell's law based on the true elevation angle; determining a bending angle by numerical integration based on the refractive indices of the altitudes between the ground station and the flight vehicle and the constant of Snell's law; determining a receiving angle of the flight vehicle based on the constant of Snell's law; determining a spherical angle based on the true elevation angle, the bending angle, and the receiving angle of the flight vehicle; and determining the direction toward the position at which the radio wave transmitted by the ground station at the true elevation angle is propagated to the same altitude as the flight vehicle, based on the spherical angle.

The updating of the apparent elevation angle range may include determining a constant of Snell's law based on the median elevation angle of the apparent elevation angle range; determining a bending angle by numerical integration based on the refractive indices of the altitudes between the ground station and the flight vehicle and the constant of Snell's law; determining a receiving angle of the flight vehicle based on the constant of Snell's law; determining a spherical angle based on the median elevation angle of the apparent elevation angle range, the bending angle, and the receiving angle of the flight vehicle; and determining the elevation angle estimated from the median elevation angle of the apparent elevation angle range, based on the spherical angle.

According to an example embodiment, there is provided an apparatus for determining an apparent elevation angle, the apparatus including: a processor configured to: determine a distance between a ground station and an altitude of a flight vehicle and a true elevation angle corresponding to a direction from the ground station toward the flight vehicle; determine a maximum elevation angle error; determine an apparent elevation angle range relative to the true elevation angle based on the maximum elevation angle error; update the apparent elevation angle range by comparing the true elevation angle and an elevation angle estimated from a median elevation angle of the apparent elevation angle range based on refractive indices of altitudes between the ground station and the flight vehicle; and determine the apparent elevation angle in response to the apparent elevation angle range being within a tolerance.

The processor may be configured to change the apparent elevation angle range to one of a first angle range and a second angle range, relative to the median elevation angle of the apparent elevation angle range, based on a result of comparing the true elevation angle and the elevation angle estimated from the median elevation angle of the apparent elevation angle range.

The processor may be configured to determine the apparent elevation angle range to be the first angle range in response to the elevation angle estimated from the median elevation angle of the apparent elevation angle range being less than the true elevation angle, and determine the apparent elevation angle range to be the second angle range in response to the elevation angle estimated from the median elevation angle of the apparent elevation angle range being greater than the true elevation angle.

The first angle range may be higher than the second angle range.

The processor may be configured to determine the apparent elevation angle to be the median elevation angle of the apparent elevation angle range, in response to the elevation angle estimated from the median elevation angle of the apparent elevation angle range being equal to the true elevation angle.

The processor may be configured to repeatedly update the apparent elevation angle range while the apparent elevation angle range is out of the tolerance.

The processor may be configured to orient an antenna of the ground station toward the determined apparent elevation angle, via a drive portion.

The processor may be configured to determine the maximum elevation angle error, using the true elevation angle and a direction toward a position at which a radio wave transmitted by the ground station at the true elevation angle is propagated to the same altitude as the flight vehicle based on the refractive indices of the altitudes between the ground station and the flight vehicle.

The processor may be configured to determine a constant of Snell's law based on the true elevation angle; determine a bending angle by numerical integration based on the refractive indices of the altitudes between the ground station and the flight vehicle and the constant of Snell's law; determine a receiving angle of the flight vehicle based on the constant of Snell's law; determine a spherical angle based on the true elevation angle, the bending angle, and the receiving angle of the flight vehicle; and determine the direction toward the position at which the radio wave transmitted by the ground station at the true elevation angle is propagated to the same altitude as the flight vehicle, based on the spherical angle.

### BRIEF DESCRIPTION OF THE DRAWINGS

FIG. 1 is a block diagram illustrating an apparatus for determining an apparent elevation angle according to an example embodiment.

FIG. 2 is a diagram illustrating a path through which a radio wave is propagated from a ground station to a flight vehicle according to an example embodiment.

FIG. 3 is a flowchart illustrating a method of determining an apparent elevation angle according to an example embodiment.

FIG. 4 is a diagram illustrating an example of determining an apparent elevation angle range according to an example embodiment.

FIG. 5 is a diagram illustrating an example of determining an apparent elevation angle according to an example embodiment.

FIG. 6 is a diagram illustrating an example of a change in an apparent elevation angle range when an elevation angle estimated from a median elevation angle of the apparent elevation angle range is greater than a true elevation angle according to an example embodiment.

FIG. 7 is a diagram illustrating an example of a change in an apparent elevation angle range when an elevation angle estimated from a median elevation angle of the apparent elevation angle range is less than a true elevation angle according to an example embodiment.

### DETAILED DESCRIPTION

The following structural or functional descriptions of example embodiments are provided to merely describe the example embodiments, and the scope of the example embodiments is not limited to the descriptions provided in the disclosure. Various changes and modifications can be made thereto by one of ordinary skill in the art.

Although the terms “first” or “second” are used to explain various components, the components are not limited to the terms. These terms should be used only to distinguish one component from another component. For example, a “first” component may be referred to as a “second” component, or similarly, the “second” component may be referred to as the “first” component within the scope of the right according to the concept of the present disclosure.

As used herein, the singular forms are intended to include the plural forms as well, unless the context clearly indicates otherwise. It should be further understood that the terms “comprises,” “comprising,” “includes,” and/or “including,” when used in this specification, specify the presence of stated features, integers, steps, operations, elements, components or a combination thereof, but do not preclude the presence or addition of one or more other features, integers, steps, operations, elements, components, and/or groups thereof. It should also be understood that when a component is referred to as being “connected to” another component, the component can be directly connected or coupled to the other component or intervening components may be present therebetween.

As used herein, “A or B,” “at least one of A and B,” “at least one of A or B,” “A, B or C,” “at least one of A, B and C,” and “A, B, or C,” each of which may include any one of the items listed together in the corresponding one of the phrases, or all possible combinations thereof.

Unless otherwise defined herein, all terms used herein including technical or scientific terms have the same meanings as those generally understood by one of ordinary skill in the art. Terms defined in dictionaries generally used should be construed to have meanings matching with contextual meanings in the related art and are not to be construed as an ideal or excessively formal meaning unless otherwise defined herein.

Hereinafter, the example embodiments will be described in detail with reference to the accompanying drawings. When describing the example embodiments with reference to the accompanying drawings, like reference numerals refer to like components, and a repeated description related thereto is omitted.

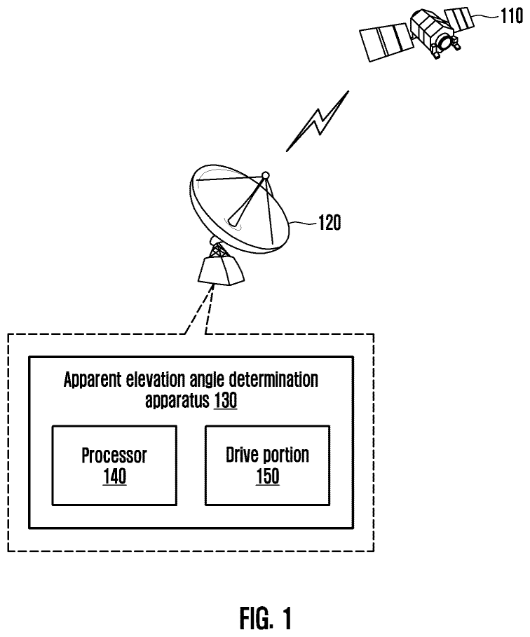

FIG. 1 is a block diagram illustrating an apparatus for determining an apparent elevation angle according to an example embodiment.

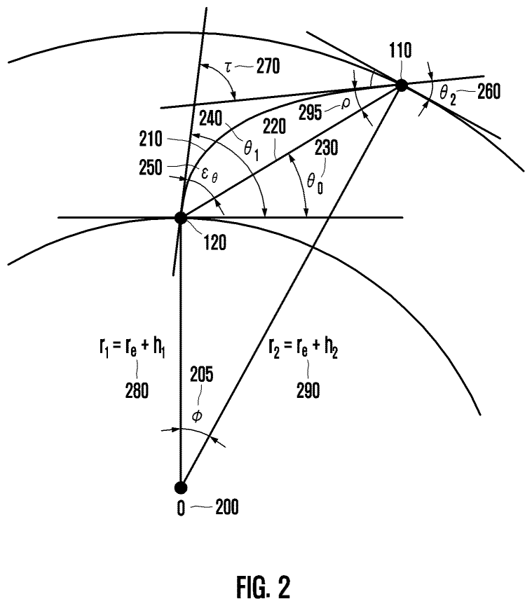

According to an example embodiment, an apparatus for determining an apparent elevation angle, or simply an “apparent elevation angle determination apparatus” 130 herein, may determine an apparent elevation angle for a flight vehicle 110 at a ground station 120. The apparent elevation angle may include at least one of an angle corresponding to a direction in which a radio wave is transmitted by the ground station 120 such that the radio wave reaches the flight vehicle 110 from the ground station 120 or an angle corresponding to a direction in which the radio wave is received by the ground station 120 when the radio wave transmitted from the flight vehicle 110 reaches the ground station 120. An angle (e.g., a true elevation angle) from a geometric viewpoint corresponding to a direction from the ground station 120 toward the flight vehicle 110 may differ from the apparent elevation angle described above. This is because the radio wave transmitted from the ground station 120 is refracted in the atmosphere between an altitude of the ground station 120 and an altitude of the flight vehicle 110. The apparent elevation angle and the true elevation angle may be angles formed relative to a horizontal plane. The apparent elevation angle and the true elevation angle will be described in more detail below with reference to FIG. 2.

For example, the apparent elevation angle determination apparatus 130 may determine an apparent elevation angle of the flight vehicle 110 at the ground station 120 based on a distance between the ground station 120 and the flight vehicle 110 and a true elevation angle corresponding to a direction from the ground station 120 toward the flight vehicle 110. The apparent elevation angle determination apparatus 130 may more accurately determine the apparent elevation angle of the flight vehicle 110 at the ground station 120, even in an environment that does not correspond to a standard atmospheric model or in a case of a low altitude of the flight vehicle 110.

The flight vehicle 110 may be an object capable of flying. The flight vehicle 110 may include, for example, a device capable of receiving waves (e.g., radio waves). The flight vehicle 110 may include, for example, an artificial satellite and a launch vehicle. The artificial satellite may be a man-made device that is launched into the outside of the atmosphere by a rocket and flies in an orbit around the Earth. The artificial satellite may include, for example, a device designed to be launched from the Earth by a rocket for a specific purpose and orbit around the Earth, such as, for example, a communication satellite, a broadcast satellite, and a weather satellite. The altitude of the artificial satellite may be, for example, from 250 kilometers (km) to 36,000 km above sea level. The launch vehicle may include, for example, a rocket designed to carry a payload including, for example, a spacecraft or satellite, from the surface of the Earth or the lower atmosphere to the outside of the atmosphere. The altitude of the launch vehicle may include all altitudes (e.g., 0 km to 10,000 km above sea level) in the atmosphere until the vehicle is out of the atmosphere after taking off from the ground, in addition to altitudes outside the atmosphere.

The ground station 120 may include a radio station located on the ground, which is designed to transmit radio waves to the flight vehicle 110 or receive radio waves from the flight vehicle 110. The ground station 120 may include the apparent elevation angle determination apparatus 130 and an antenna. The antenna may include a device for emitting, as an electromagnetic wave, an alternating voltage modulated by a transmitter into the atmosphere. For example, the antenna may transmit a radio wave in an oriented direction. For example, the ground station 120 may use the radio wave to communicate with the flight vehicle 110 and/or track a position of the flight vehicle 110.

The apparent elevation angle determination apparatus 130 may include at least one of a processor 140 or a drive portion 150. The apparent elevation angle determination apparatus 130 may use the processor 140 to determine an apparent elevation angle of the flight vehicle 110 at the ground station 120 based on a true elevation angle of the flight vehicle 110 and a distance between the ground station 120 and the flight vehicle 110. The ground station 120 may orient the antenna of the ground station 120 toward the determined apparent elevation angle via the drive portion 150.

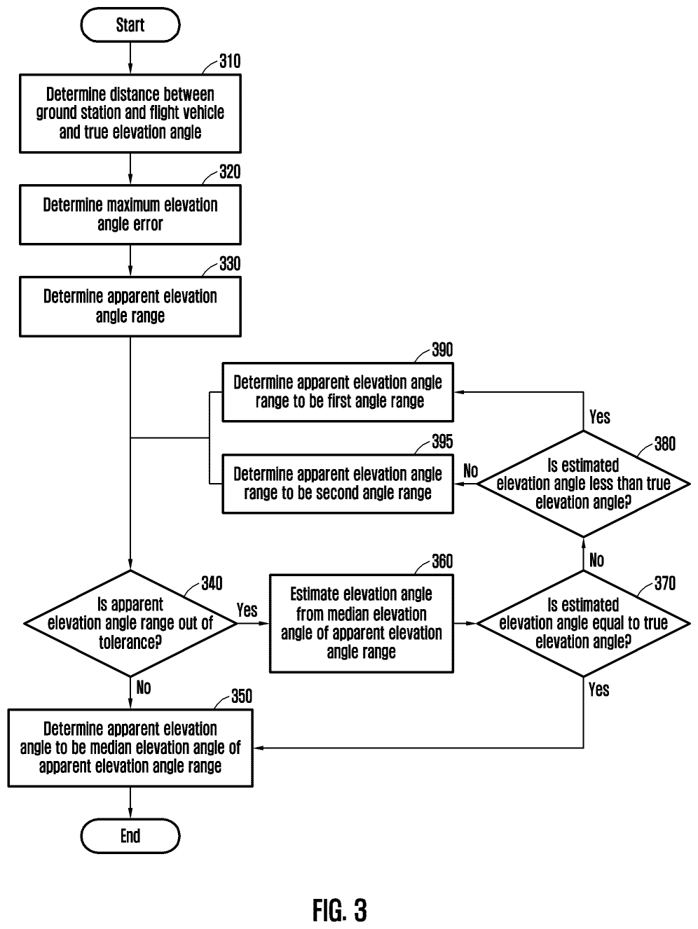

The processor 140 may determine the true elevation angle of the flight vehicle 110 and the distance between the ground station 120 and the flight vehicle 110. For example, the true elevation angle and the distance between the ground station 120 and the flight vehicle 110 may be input to the processor 140 by a user. The processor 140 may determine a maximum elevation angle error, using the true elevation angle and a direction toward a position at which a radio wave transmitted by the ground station 120 at the true elevation angle is propagated to the same altitude as the flight vehicle 110 based on refractive indices of altitudes between the ground station 120 and the flight vehicle 110. Based on the determined maximum elevation angle error, the processor 140 may determine an apparent elevation angle range relative to the true elevation angle. The processor 140 may update the apparent elevation angle range by comparing the true elevation angle and an elevation angle estimated from a median elevation angle of the determined apparent elevation angle range based on the refractive indices of the altitudes between the ground station 120 and the flight vehicle 110. In this case, the processor 140 may repeatedly update the apparent elevation angle range. In response to the apparent elevation angle range being less than or equal to (or within) a tolerance, the processor 140 may determine an apparent elevation angle. The processor 140 may change the apparent elevation angle range to one of a first angle range and a second angle range relative to the median elevation angle of the apparent elevation angle range, based on a result of comparing the true elevation angle and the elevation angle estimated from the median elevation angle of the apparent elevation angle range. How the processor 140 determines an apparent elevation angle will be described in detail below with reference to FIGS. 3 through 7.

According to an example embodiment, the drive portion 150 may orient the antenna of the ground station 120 toward an apparent elevation angle relative to the flight vehicle 110 by the processor 140. The drive portion 150 may include, for example, a motor. The drive portion 150 may drive the motor to orient the antenna in a direction of the apparent elevation angle.

It is to be noted that, although an example where the apparent elevation angle determination apparatus 130 is included in the ground station 120 is described herein, examples are not limited thereto. The apparent elevation angle determination apparatus 130 and the ground station 120 may be separate, and the ground station 120 may include the drive portion 150. In this case, the apparent elevation angle determination apparatus 130 may provide an estimated apparent elevation angle to the ground station 120. The ground station 120 may then use the estimated apparent elevation angle to orient the antenna via the drive portion 150.

FIG. 2 is a diagram illustrating a path through which a radio wave is propagated from a ground station to a flight vehicle according to an example embodiment.

A radio wave may be transmitted from a ground station 120 toward an apparent elevation angle 240. The transmitted radio wave may travel along a propagation path 210. FIG. 2 illustrates an example where the radio wave traveling along the propagation path 210 is received by a flight vehicle 110 at a specific altitude. The flight vehicle 110 may receive the radio wave in a direction corresponding to a receiving angle 260. The radio wave may be refracted such that a difference between a propagation direction of the radio wave and a direction parallel to a horizontal plane of the Earth (e.g., a direction parallel to the surface of a sphere relative to the center of the Earth (or simply an “earth center” herein)) depending on an atmospheric refraction of the radio wave is reduced as the radio wave is propagated.

A refractive index of an altitude at which the ground station 120 is located may be higher than a refractive index of an altitude at which the flight vehicle 110 is located. A refractive index may indicate a degree to which a wave passing through the interface of different media is refracted. The refractive index may be expressed by a refractivity according to Equation 1 below.

$$N = ( n - 1 ) \times {10}^{6} \qquad [ Equation 1 ]$$

In Equation 1 above, N may denote a refractivity, and n may denote a refractive index. The refraction of a radio wave within a frequency band may be greatly affected by the troposphere, which is a region of the atmosphere from the ground to an altitude of 30 km. In a case where the frequency band is in a range of 3 megahertz (MHz) to 30 gigahertz (GHz) in the troposphere, an atmospheric refractivity may be expressed by Equation 2.

$$\begin{matrix}N = 77.6 \frac{{P}_{d}}{{T}_{k}} + 72 \frac{e}{{T}_{k}} + 3.75 \times {10}^{5} \frac{e}{{T}_{k}^{2}} \\ \approx \frac{77.6}{{T}_{k}} ( P + 4810 \frac{e}{{T}_{k}} )\end{matrix} \qquad [ Equation 2 ]$$

In Equation 2 above, Tₖ may denote an atmospheric temperature expressed in the unit of absolute temperature, and P may denote an atmospheric pressure expressed in the unit of hectopascal (hPa). P_{d} may denote a dry atmospheric pressure expressed in the unit of hectopascals. e may denote a water vapor pressure expressed in the unit of hectopascals, which may be a difference between the atmospheric pressure and the dry atmospheric pressure. A refractivity at a specific altitude may be expressed by Equation 3.

$$\begin{matrix}N ( h ) = {N}_{s} exp ( - k ( h - {h}_{s} ) ) \\ = {N}_{0} exp ( - kh ) \\ = {N}_{0} exp ( - h / {h}_{0} )\end{matrix} \qquad [ Equation 3 ]$$

In Equation 3 above, hₛ may denote a surface altitude, and Nₛ may denote a surface refractivity at the altitude hₛ. k may denote an attenuation constant, and h₀ may denote a scale altitude. N₀ may denote a refractivity at sea level, which is represented as “N₀=Nₛ×exp (khₛ).” Given a refractivity N at an altitude h, the scale altitude may be expressed by Equation 4.

$$\begin{matrix}{h}_{0} = - \frac{h - {h}_{s}}{ln N - ln {N}_{s}} \\ = - \frac{Δ h}{ln ( {N}_{s} + Δ N ) - ln {N}_{s}}\end{matrix} \qquad [ Equation 4 ]$$

In Equation 4 above, “ΔN=N−Nₛ” may represent an increment of the refractivity at the altitude h with respect to the surface refractivity, and “Δh=h−hₛ” may represent an increment of the altitude with respect to the surface altitude. In addition, a modeled refractivity increment ΔN may be expressed by Equation 5.

$$Δ N = - 7.32 exp ( 0.005577 {N}_{s} ) \qquad [ Equation 5 ]$$

In Equation 5 above, Nₛ may denote a refractivity at an altitude hₛ, and ΔN may denote a refractivity increment with respect to the surface refractivity at an altitude increment Δh of 1 km. In a case where the surface altitude and the surface refractivity are known, a refractivity according to an altitude may be modeled as expressed in Equation 3 based on Equations 4 and 5 above.

An earth center 200, which is a point indicating the center of the Earth, may represent the center of a sphere including the surface of the Earth when the Earth is modeled in the form of a sphere including the surface of the Earth. Given a spherical coordinate system with the earth center 200 being at the center, Snell's law for a refractive index may be expressed by Equation 6.

$$n ( r ) \cdot r \cdot cos θ ( r ) = C \qquad [ Equation 6 ]$$

In Equation 6 above, r may denote a distance from the earth center 200, and n(r) may denote a refractive index with respect to the distance r from the earth center 200. θ(r) may denote an angle formed between a direction in which the radio wave travels when it is far away from the earth center 200 by “r” and a tangent plane of the sphere which has a radius of “r” and has the earth center 200 as the center. C may denote a constant of Snell's law.

A spherical angle 205 may represent an angle formed between a straight line connecting the earth center 200 and the ground station 120 and a straight line connecting the earth center 200 and the flight vehicle 110.

The propagation path 210 of the radio wave may include a path through which the radio wave passes when the radio wave is emitted from the ground station 120 toward the apparent elevation angle 240 to reach the flight vehicle 110. The propagation path 210 of the radio wave may be convexly bent in a direction opposite the Earth by successive refractions of the radio wave.

A distance 220 between the ground station 120 and the flight vehicle 110 may include a straight distance connecting a position of the ground station 120 and a position of the flight vehicle 110. For example, a processor may receive a user input indicating the distance 220 between the ground station 120 and the flight vehicle 110 and a true elevation angle 230. The distance 220 between the ground station 120 and the flight vehicle 110 may be used, along with the true elevation angle 230 and a distance 280 of the ground station 120 from the earth center 200, to calculate an altitude of the flight vehicle 110.

The true elevation angle 230 may include an angle formed between the straight line connecting the ground station 120 and the flight vehicle 110 and the horizontal plane. The true elevation angle 230 may be determined, along with the distance 220 between the ground station 120 and the flight vehicle 110, by the processor. For example, the true elevation angle 230 may be input to the processor along with the distance 220 between the ground station 120 and the flight vehicle 110. The true elevation angle 230 may be used, along with the distance 220 between the ground station 120 and the flight vehicle 110 and the distance 280 of the ground station 120 from the earth center 200, to calculate the altitude of the flight vehicle 110. The true elevation angle 230 may be used to calculate a maximum elevation angle error. Calculating the maximum elevation angle error will be described in detail below with reference to FIG. 3. The true elevation angle 230 may be a basis for an initial range of the apparent elevation angle 240. The true elevation angle 230 may be compared to an elevation angle estimated from a median elevation angle of the initial range of the apparent elevation angle 240 in a step of updating the range of the apparent elevation angle 240. Setting the initial range of the apparent elevation angle 240 and updating the range of the apparent elevation angle 240 will be described in detail below with reference to FIGS. 3 through 7. The true elevation angle 230 may be less than the apparent elevation angle 240.

The apparent elevation angle 240 may be an angle formed, when the radio wave transmitted by the ground station 120 reaches the flight vehicle 110, between the direction in which the ground station 120 transmits the radio wave and the horizontal plane. The apparent elevation angle 240 may be determined by the processor from the true elevation angle 230 and the distance 220 between the ground station 120 and the flight vehicle 110. The apparent elevation angle 240 may be a sum of the true elevation angle 230 and an elevation angle error 250.

The elevation angle error 250 may be an angle formed, when the radio wave transmitted from the ground station 120 reaches the flight vehicle 110, between the direction in which the radio wave is transmitted from the ground station 120 and the straight line connecting the flight vehicle 110 and the ground station 120. The elevation angle error 250 may be a difference between the apparent elevation angle 240 and the true elevation angle 230. The elevation angle error 250 may be determined, along with the apparent elevation angle 240, in a step of determining the apparent elevation angle 240. The elevation angle error 250 may be expressed by Equation 7.

$${ϵ}_{θ} = τ - ρ \qquad [ Equation 7 ]$$

In Equation 7 above, ϵ_{θ} may denote the elevation angle error 250, and [symbol] may denote a bending angle 270. ρ may denote an angle 295 formed between a direction in which the radio wave is received by the flight vehicle 110 and the straight line connecting the ground station 120 and the flight vehicle 110.

The receiving angle 260 of the flight vehicle 110 may be an angle formed, when the radio wave transmitted from the ground station 120 reaches the flight vehicle 110, between the direction in which the radio wave is received by the flight vehicle 110 and the tangent plane between the sphere having the earth center 200 as the center and the flight vehicle 110.

The bending angle 270 may be an angle formed, when the radio wave transmitted from the ground station 120 reaches the flight vehicle 110, between the direction in which the radio wave is transmitted from the ground station 120 and the direction in which the radio wave is received by the flight vehicle 110. Based on a successive change in refractive index between the ground station 120 and the flight vehicle 110 along the propagation path 210 of the radio wave, the bending angle 270 may be calculated as expressed by Equation 8.

$$τ = - {\int }_{{n}_{1}}^{{n}_{2}} \frac{1}{n ( r ) tan θ ( r )} dn \qquad [ Equation 8 ]$$

In Equation 8, τ may denote the bending angle 270, and r may denote a distance from the earth center 200. n(r) may denote a refractive index with respect to the distance r from the earth center 200, and θ(r) may denote an angle formed between a direction in which a radio wave travels and a tangent plane of a sphere that has the earth center 200 as a center and has a radius of “r,” when the radio wave is far away from the earth center 200 by the distance r. n₁ may denote an atmospheric refractive index at the ground station 120, and n₂ may denote an atmospheric refractive index at the flight vehicle 110.

The distance 280 of the ground station 120 from the earth center 200 may be a sum of the altitude of the ground station 120 and the radius of the Earth. A distance 290 of the flight vehicle 110 from the earth center 200 may be a sum of the altitude of the flight vehicle 110 and the radius of the Earth. The altitude of the flight vehicle 110 may be calculated based on the distance 220 between the ground station 120 and the flight vehicle 110, the distance 280 of the ground station 120 from the earth center 200, and the true elevation angle 230. As will be described later, Equation 8 may require a great amount of calculation or computation and may thus be approximated according to Equation 9 below.

FIG. 3 is a flowchart illustrating a method of determining an apparent elevation angle (or simply an “apparent elevation angle determination method” herein) according to an example embodiment.

At operation 310, a processor of an apparent elevation angle determination apparatus may determine a distance between a ground station and a flight vehicle and a true elevation angle corresponding to a direction from the ground station toward the flight vehicle. For example, a user may input the distance between the ground station and the flight vehicle and the true elevation angle into the processor. The processor may also calculate an altitude of the flight vehicle from the input distance between the ground station and the flight vehicle, the input true elevation angle, and a distance of the ground station from an earth center.

At operation 320, the processor may determine a maximum elevation angle error, using the true elevation angle and a direction toward a position at which a radio wave transmitted by the ground station at the true elevation angle is propagated to the same altitude as the flight vehicle based on refractive indices of altitudes between the ground station and the flight vehicle. The maximum elevation angle error may be a maximum value of an elevation angle error. The maximum elevation angle error may be an angle formed between a direction of the true elevation angle from the ground station and the direction toward the position at which the radio wave transmitted by the ground station at the true elevation angle is propagated to the same altitude as the flight vehicle based on the refractive indices of the altitudes between the ground station and the flight vehicle.

According to an example embodiment, the processor may estimate a constant of Snell's law according to Equation 6 above based on an apparent elevation angle, a refractive index at the ground station, and the distance of the ground station from the earth center. The processor may estimate a receiving angle of the flight vehicle from the estimated constant of Snell's law, a refractive index at the flight vehicle, and a distance of the flight vehicle from the earth center. The processor may also estimate a bending angle based on the refractive index at the ground station and the refractive index at the flight vehicle. The processor may estimate a spherical angle from the receiving angle of the flight vehicle, the apparent elevation angle, and the bending angle. The processor may estimate an elevation angle (e.g., an elevation angle predicted to be the true elevation angle) from the estimated spherical angle, the distance of the ground station from the earth center, and the distance of the flight vehicle from the earth center.

The bending angle may be calculated by numerical integration (e.g., Gaussian quadrature or trapezoidal rule) based on Equation 8 above. For example, the bending angle may be calculated by an I-point Gaussian quadrature. Based on the I-point Gaussian quadrature, Equation 8 above may be approximated as expressed by Equation 9 below.

$$\begin{matrix}τ \approx \frac{{n}_{1} - {n}_{2}}{2} {\sum }_{i = 1}^{I} \frac{{w}_{i}}{{\overline{n}}_{i} tan {\overline{θ}}_{i}} \\ = C \frac{{n}_{1} - {n}_{2}}{2} {\sum }_{i = 1}^{I} \frac{{w}_{i}}{{\overline{n}}_{i} \sqrt{{\overline{n}}_{i}^{2} {\overline{r}}_{i}^{2} - {C}^{2}}}\end{matrix} \qquad [ Equation 9 ]$$

In Equation 9 above,

$${\overline{n}}_{i} = \frac{( {n}_{1} - {n}_{2} ) {x}_{i} + {n}_{1} + {n}_{2}}{2}$$

and N̅ᵢ=(n̅ᵢ−1)×10⁶Also, h̅ᵢ=ln(N₀/N̅ᵢ)·h₀ and r̅ᵢ=rₑ+h̅ᵢ. In addition,

$${\overline{θ}}_{i} = {cos}^{- 1} ( \frac{C}{{\overline{n}}_{i} {\overline{r}}_{i}} ) and$$

$$tan {\overline{θ}}_{i} = \frac{\sqrt{{\overline{n}}_{i}^{2} {\overline{r}}_{i}^{2} - {C}^{2}}}{C} .$$

n₁ may denote the refractive index at the ground station, and n₂ may denote the refractive index at the flight vehicle. n̅_{ι} may denote a refractive index corresponding to an i-th altitude between an altitude corresponding to the ground station and an altitude corresponding to the flight vehicle. i may be an integer greater than or equal to 1 and less than or equal to I, and I may be an integer greater than or equal to 2. xᵢ may denote an abscissa in the Gaussian quadrature, and wᵢ may denote a weight in the Gaussian quadrature. C may denote the constant of Snell's law, and rₑ may denote a radius of the Earth. N₀ may denote a refractive index at sea level, and h₀ may denote a scale altitude.

According to an example embodiment, determining the direction toward the position at which the radio wave transmitted by the ground station at the true elevation angle is propagated to the same altitude of the flight vehicle may be performed according to Algorithm 1 below, based on the I-point Gaussian quadrature.

Algorithm 1: Function f to Determine \hat{θ}_{0|\hat{θ}1}, by an
I-Point Gaussian Quadrature.

```
for i ← 1 to I do
  ${\overline{n}}_{i} ← \frac{( {n}_{1} - {n}_{2} ) {x}_{i} + {n}_{1} + {n}_{2}}{2}$
  N̅ᵢ ← (n̅ᵢ − 1) × 10⁶
  r̅ᵢ ← rₑ + ln(N₀/N̅ᵢ) · h₀
end for
Ĉ ← n₁r₁cos\hat{θ}₁
$\hat{τ} ← \hat{C} \frac{{n}_{1} - {n}_{2}}{2} {\sum }_{i = 1}^{I} \frac{{w}_{i}}{{\overline{n}}_{i} \sqrt{{\overline{n}}_{i}^{2} {\overline{r}}_{i}^{2} - {\hat{C}}^{2}}}$
${\hat{θ}}_{2} ← {cos}^{- 1} - ( \frac{\hat{C}}{{n}_{2} {r}_{2}} )$
\hat{ϕ} ← \hat{θ}₂ − \hat{θ}₁ + \hat{τ}
${\hat{θ}}_{0 \vert {\hat{θ}}_{1}} ← {tan}^{- 1} ( \frac{{r}_{2} cos \hat{ϕ} - {r}_{1}}{{r}_{2} sin \hat{ϕ}} )$
```

In Algorithm 1 above, I may denote an order (or point) of the Gaussian quadrature, n₁ may denote an atmospheric refractive index at the ground station, and n₂ may denote an atmospheric refractive index at the flight vehicle. xᵢ may denote an abscissa in the Gaussian quadrature, and wᵢ may denote a weight in the Gaussian quadrature. n̅_{ι} may denote a refractive index corresponding to an i-th altitude between an altitude corresponding to the ground station and an altitude corresponding to the flight vehicle. i may be an integer greater than or equal to 1 and less than or equal to I, and I may be an integer greater than or equal to 2. Ĉ may denote an estimated value of the constant of Snell's law, and rₑ may denote the radius of the Earth. N₀ may denote the refractive index at sea level, and h₀ may denote the scale altitude. r₁ may denote a distance of the ground station from the earth center, and r₂ may denote a distance of the flight vehicle from the earth center. \hat{θ}₁ may denote an estimated value of the apparent elevation angle, and \hat{θ}₂ may denote an estimated value of the receiving angle of the flight vehicle. \hat{τ} may denote an estimated value of the bending angle, and \hat{ϕ} may denote an estimated value of the spherical angle. \hat{θ}_{0|\hat{θ}}_{₁} may denote an estimated value of the true elevation angle, which is estimated from \hat{θ}₁. In Algorithm 1 above, the first to fifth lines and the seventh line may represent the estimation of the bending angle according to the I-point Gaussian quadrature. The sixth line may represent the estimation of the constant of Snell's law according to Snell's law, and the eighth line may represent the estimation of the receiving angle of the flight vehicle according to Snell's law. The ninth line may represent the estimation of the spherical angle based on a schematic relationship of the angles shown in FIG. 2, and the tenth line may represent the estimation of the elevation angle based on the estimated spherical angle. For example, abscissae and weights of a 10-point order Gaussian quadrature may be expressed as shown in Table 1 below.

TABLE 1

| Abscissae | Weights |
|---|---|
| x₁ = 0.148874338981631 | w₁ = 0.295524224714753 |
| x₂ = 0.433395394129247 | w₂ = 0.269266719309996 |
| x₃ = 0.679409568299024 | w₃ = 0.219086362515982 |
| x₄ = 0.865063366688985 | w₄ = 0.149451349150581 |
| x₅ = 0.973906528517172 | w₅ = 0.066671344308688 |

Also, for i=6 to 10, xᵢ=−xᵢ₋₅ and wᵢ=wᵢ₋₅. The bending angle in Algorithm 1 above may be calculated by the trapezoidal rule in addition to the I-point Gaussian quadrature. Based on the trapezoidal rule, Equation 8 above may be approximated as expressed by Equation 10 below.

$$τ \approx \frac{Δ n}{2} ( \frac{1}{{n}_{1} tan {θ}_{1}} + 2 {\sum }_{k = 1}^{K - 1} \frac{1}{{\dot{n}}_{k} tan {\dot{θ}}_{k}} + \frac{1}{{n}_{2} tan {θ}_{2}} ) \qquad [ Equation 10 ]$$

In Equation 10 above, K may denote the number of panels, which may be an integer greater than or equal to 2. Also,

$$Δ n = \frac{{n}_{1} - {n}_{2}}{K} ,$$

and \dot{n}ₖ=n₂+kΔn. n₁ may denote the refractive index at the ground station, and n₂ may denote the refractive index at the flight vehicle. θ₁ may denote the apparent elevation angle at the ground station, and θ₂ may denote the receiving angle of the flight vehicle. In addition, tan \dot{θ}ₖ may be determined similarly to tan θ̅ᵢ in Equation 9 above. k may be an integer greater than or equal to 1 and less than or equal to K−1. Algorithm 1 above may be used to estimate \hat{θ}_{0|\hat{θ}}_{₁} from \hat{θ}₁. For example, a direction of \hat{θ}_{0|\hat{θ}}_{₁} estimated from \hat{θ}₁ which has the same value as the true elevation angle using Algorithm 1 above may be the direction toward the position at which the radio wave transmitted by the ground station at the true elevation angle is propagated to the same altitude as the flight vehicle. Although the I-point Gaussian quadrature and the trapezoidal rule are described as numerical integration methods for calculating the bending angle, examples of the numerical integration methods are not limited to those described above.

According to an example embodiment, the processor may determine the maximum elevation angle error to be an empirical value. For example, the maximum elevation angle error may be determined based on the empirical value. The empirical value may refer to a value determined empirically, which may be determined by a statistical method. The processor may collect elevation angle error values, and may determine a statistical value (e.g., a maximum value) of the collected elevation angle error values as the maximum elevation angle error. The processor may determine the maximum elevation angle error to be a value that is obtained by applying a margin to the statistical value of the collected elevation angle error values. For example, the processor may determine the maximum elevation angle error by adding the margin to the maximum value of the collected elevation angle error values. However, examples are not limited thereto, and the processor may also receive the empirical value for the maximum elevation angle error that is manually input from a user.

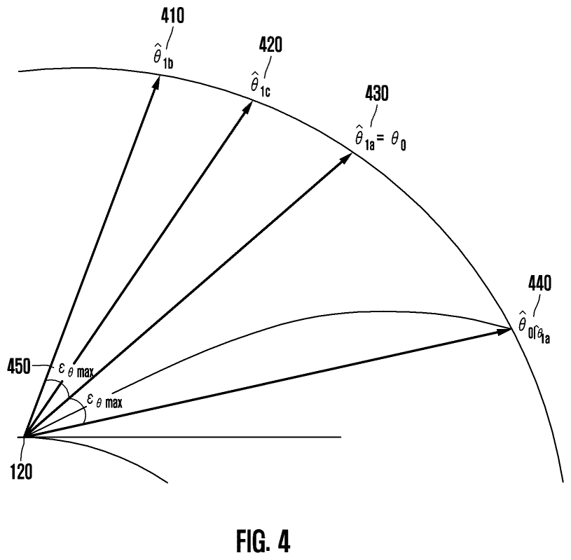

Determining the maximum elevation angle error will be described in detail below with reference to FIG. 4.

At operation 330, the processor may determine an apparent elevation angle range that is based on the true elevation angle, based on the determined maximum elevation angle error. The apparent elevation angle range may refer to a range from which an apparent elevation angle is determined. A minimum elevation angle in the apparent elevation angle range may include a minimum value of the apparent elevation angle range. For example, the minimum elevation angle in the apparent elevation angle range may be determined to be the same value as the true elevation angle. A maximum elevation angle in the apparent elevation angle range may include a maximum value of the apparent elevation angle range. For example, the maximum elevation angle in the apparent elevation angle range may be determined to be a sum of the true elevation angle and the maximum elevation angle error. Determining the apparent elevation angle range will be described in detail below with reference to FIG. 4.

At operation 340, the processor may compare the apparent elevation angle range and a tolerance. Based on a result of comparing the apparent elevation angle range and the tolerance, the processor may determine whether to perform operation 350 or operation 360. For example, in response to the apparent elevation angle range exceeding (or out of) the tolerance, the processor may perform operation 360. In this case, the processor may perform a bisection search over the apparent elevation angle range. In response to the apparent elevation angle range being less than or equal to (or within) the tolerance, the processor may perform operation 350. The tolerance may be determined based on a beam width of an antenna of the ground station, for example.

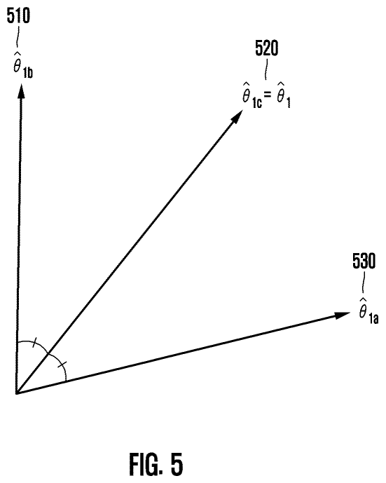

At operation 350, the processor may determine the apparent elevation angle to be a median elevation angle of the apparent elevation angle range. The median elevation angle of the apparent elevation angle range may be a median value between the maximum elevation angle in the apparent elevation angle range and the minimum elevation angle in the apparent elevation angle range. Determining the apparent elevation angle will be described in detail below with reference to FIG. 5.

At operation 360, the processor may estimate an elevation angle from the median elevation angle of the apparent elevation angle range. According to an example embodiment, the processor may estimate a constant of Snell's law by Equation 6 above, based on the apparent elevation angle, the refractive index at the ground station, and the distance of the ground station from the earth center. The processor may estimate a receiving angle of the flight vehicle from the estimated constant of Snell's law, the refractive index at the flight vehicle, and the distance of the flight vehicle from the earth center. The processor may also estimate a bending angle based on the refractive index at the ground station and the refractive index at the flight vehicle. The processor may estimate a spherical angle from the receiving angle of the flight vehicle, the apparent elevation angle, and the bending angle. The processor may estimate the elevation angle (e.g., an elevation angle predicted to be the true elevation angle) from the estimated spherical angle, the distance of the ground station from the earth center, and the distance of the flight vehicle from the earth center. The bending angle may be calculated by numerical integration (e.g., the Gaussian quadrature or the trapezoidal rule) based on Equation 8 above. For example, the bending angle may be calculated according to Algorithm 1 above based on the I-point Gaussian quadrature. For example, in Algorithm 1 above, the bending angle may also be calculated by the trapezoidal rule.

At operation 370, the processor may determine whether the elevation angle estimated from the median elevation angle of the apparent elevation angle range is equal to the true elevation angle. The elevation angle estimated from the median elevation angle of the apparent elevation angle range may be interpreted as an elevation angle corresponding to a direction toward a position at which the radio wave, when transmitted at the median elevation angle, reaches the altitude of the flight vehicle. In response to the estimated elevation angle being equal to the true elevation angle, the processor may perform operation 350. For example, in response to the elevation angle estimated from the median elevation angle of the apparent elevation angle range being equal to the true elevation angle, the processor may determine the apparent elevation angle to be the median elevation angle of the apparent elevation angle range. In response to the estimated elevation angle being different from the true elevation angle, the processor may perform operation 380.

At operation 380, the processor may compare the estimated elevation angle and the true elevation angle. Based on a result of comparing the estimated elevation angle and the true elevation angle, the processor may determine whether to determine the apparent elevation angle range at operation 390 or at operation 395.

At operation 390, in response to the elevation angle estimated from the median elevation angle of the apparent elevation angle range being less than the true elevation angle, the processor may determine the apparent elevation angle range to be a first angle range. The first angle range may be a range in which a maximum elevation angle is equal to the maximum elevation angle in the previous apparent elevation angle range and a minimum elevation angle is equal to the median elevation angle in the previous apparent elevation angle range. As the apparent elevation angle range is determined to be the first angle range, the apparent elevation angle range may be changed. After the apparent elevation angle range is determined to be the first angle range, the processor may perform operation 340.

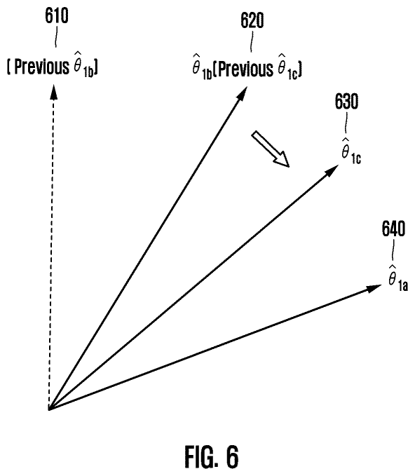

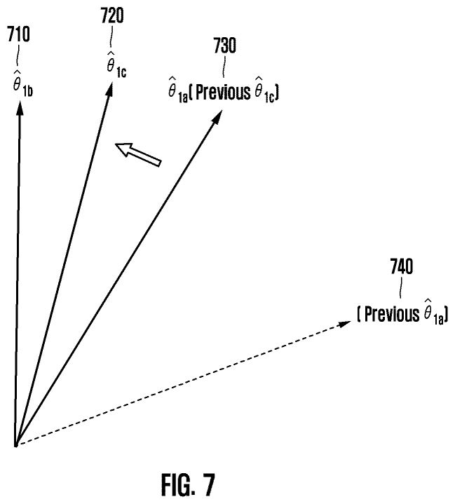

At operation 395, in response to the elevation angle estimated from the median elevation angle of the apparent elevation angle range being greater than the true elevation angle, the processor may determine the apparent elevation angle range to be a second angle range. The second angle range may be a range in which a maximum elevation angle is equal to the median elevation angle in the previous apparent elevation angle range and a minimum elevation angle is equal to the minimum elevation angle in the previous apparent elevation angle range. The first angle range may be higher than the second angle range. As the apparent elevation angle range is determined to be the second angle range, the apparent elevation angle range may be changed. After the apparent elevation angle range is determined to be the second angle range, the processor may perform operation 340. Changing the apparent elevation angle range will be described in detail below with reference to FIGS. 6 and 7.

The apparent elevation angle determination method described above may be represented as Algorithm 2 below.

Algorithm 2: Estimation Procedure of θ₁ and ϵ_{θ}.

```
\hat{θ}₁_{ₐ} ← θ₀
\hat{θ}_{0|\hat{θ}}_{₁ₐ} ← f(\hat{θ}₁_{ₐ})
ϵ_{θmax} ← \hat{θ}₁_{ₐ} − \hat{θ}_{0|\hat{θ}}_{₁ₐ}
\hat{θ}₁_{_{b}} ← θ₀ + ϵ_{θmax}
${\hat{θ}}_{{1}_{c}} ← \frac{{\hat{θ}}_{{1}_{a}} + {\hat{θ}}_{{1}_{b}}}{2}$
while \hat{θ}₁_{_{b}} − \hat{θ}₁_{ₐ} > ϵ_{toI} do
  \hat{θ}_{0|\hat{θ}}_{_{1c}} ← f(\hat{θ}₁_{_{c}})
  if \hat{θ}_{0|\hat{θ}}_{_{1c}} − θ₀ = 0 then
    Stop
  $else if {\hat{θ}}_{0 \vert {\hat{θ}}_{1 c}} - {θ}_{0} < 0 then$
    \hat{θ}₁_{ₐ} ← \hat{θ}₁_{_{c}}
  else
    \hat{θ}₁_{_{b}} ← \hat{θ}₁_{_{c}}
  end if
  ${\hat{θ}}_{{1}_{c}} ← \frac{{\hat{θ}}_{{1}_{a}} + {\hat{θ}}_{{1}_{b}}}{2}$
end while
\hat{θ}₁ ← \hat{θ}₁_{_{c}}
\hat{ϵ}_{θ} ← \hat{θ}₁ − θ₀
```

In Algorithm 2 above, θ₀ may denote the true elevation angle, and \hat{θ}₁_{ₐ} may denote the minimum elevation angle in the apparent elevation angle range. A function “f” may represent the estimation of an elevation angle according to Algorithm 1 above, and

$${\hat{θ}}_{0 \vert {\hat{θ}}_{{1}_{a}}}$$

may represent an estimated value of the true elevation angle, which is estimated from \hat{θ}₁_{ₐ}. ∈_{θ max} may denote the maximum elevation angle error, and \hat{θ}₁_{_{b}} may denote the maximum elevation angle in the apparent elevation angle range. \hat{θ}₁_{_{c}} may denote the median elevation angle in the apparent elevation angle range, and \hat{θ}₁ may denote a determined apparent elevation angle. \hat{∈}_{θ} may denote a determined elevation angle error. In Algorithm 2 above, the first to third lines may represent an operation of determining the maximum elevation angle error based on the distance between the ground station and the flight vehicle and the true elevation angle. The first, fourth, and fifth lines may represent an operation of determining the apparent elevation angle range based on the determined maximum elevation angle error. The sixth to 16th lines may represent an operation of performing a bisection search by repeatedly updating the apparent elevation angle range, and the 17th and 18th lines may represent an operation of determining the apparent elevation angle and the elevation angle error.

FIG. 4 is a diagram illustrating an example of determining an apparent elevation angle range according to an example embodiment.

According to an example embodiment, at operation 320 and operation 330, a maximum elevation angle error ∈_{θ max}. 450 may include an angle formed, when a radio wave is transmitted from a ground station 120 toward a true elevation angle θ₀, by the true elevation angle and a direction toward a position at which the radio wave is propagated to the same altitude as a flight vehicle, as shown in FIG. 4. That is, at operation 320, the maximum elevation angle error ∈_{θ max} 450 may include an angle formed by (or between) an elevation angle

$${\hat{θ}}_{0 \vert {\hat{θ}}_{{1}_{a}}}$$

440 estimated from a minimum elevation angle \hat{θ}₁_{ₐ} 430 in an apparent elevation angle range that has the same value as the true elevation angle and the minimum elevation angle \hat{θ}₁_{ₐ} 430 in the apparent elevation angle range. The minimum elevation angle 430 in the apparent elevation angle range may be determined to be the same elevation angle as the true elevation angle. A maximum elevation angle \hat{θ}₁_{_{b}} 410 in the initial apparent elevation angle range may be determined to be a sum of the minimum elevation angle 430 in the apparent elevation angle range and the maximum elevation angle error 450. A median elevation angle \hat{θ}₁_{_{c}} 420 of the initial apparent elevation angle range may be an elevation angle having a median value between the minimum elevation angle 430 and the maximum elevation angle 410 in the apparent elevation angle range.

FIG. 5 is a diagram illustrating an example of determining an apparent elevation angle according to an example embodiment.

According to an example embodiment, when an elevation angle estimated from a median elevation angle \hat{θ}₁_{_{c}} 520 in an apparent elevation angle range is equal to a true elevation angle at operation 370, or when an apparent elevation angle range is within (or less than or equal to) a tolerance at operation 340, the median elevation angle 520 of the apparent elevation angle range may be determined to be an apparent elevation angle \hat{θ}₁. For example, the determined apparent elevation angle may be output by a processor of an apparent elevation angle determination apparatus according to an example embodiment. The processor may orient an antenna of a ground station toward the determined apparent elevation angle. For example, the processor may orient the antenna of the ground station toward the determined apparent elevation angle via the ground station or a drive portion of the apparent elevation angle determination apparatus. The apparent elevation angle range may be a range of angles between a maximum elevation angle \hat{θ}₁_{_{b}} 510 in the apparent elevation angle range and a minimum elevation angle \hat{θ}₁_{ₐ} 530 in the apparent elevation angle range. The median elevation angle 520 of the apparent elevation angle range may be an elevation angle having a median value between the maximum elevation angle 510 in the apparent elevation angle range and the minimum elevation angle 530 in the apparent elevation angle range.

FIG. 6 is a diagram illustrating an example of a change in an apparent elevation angle range when an elevation angle estimated from a median elevation angle of the apparent elevation angle range is greater than a true elevation angle according to an example embodiment.

According to an example embodiment, in response to an elevation angle estimated from a median elevation angle of an apparent elevation angle range being greater than a true elevation angle at operation 380 and operation 395 described above, the apparent elevation angle range may be determined to be a second angle range. The second angle range may be lower than a first angle range. The first angle range may be one of two ranges obtained by bisecting the apparent elevation angle range, and the second angle range may be the other of the two ranges. Accordingly, a new apparent elevation angle range (e.g., an apparent elevation angle range after change) may be a range corresponding to half of the previous apparent elevation angle range (e.g., the apparent elevation angle range before the change). A maximum elevation angle 620 in the new apparent elevation angle range may be determined to be the same elevation angle as the median elevation angle of the previous apparent elevation angle range. A minimum elevation angle 640 in the new apparent elevation angle range may be determined to be the same elevation angle as a minimum elevation angle in the previous apparent elevation angle range. A median elevation angle 630 of the new apparent elevation angle range may be determined to be an elevation angle having a median value between the maximum elevation angle 620 in the new apparent elevation angle range and the minimum elevation angle 640 in the new apparent elevation angle range.

FIG. 7 is a diagram illustrating an example of a change in an apparent elevation angle range when an elevation angle estimated from a median elevation angle of the apparent elevation angle range is less than a true elevation angle according to an example embodiment.

According to an example embodiment, in response to an elevation angle estimated from a median elevation angle of an apparent elevation angle range being less than a true elevation angle at operation 380 and operation 390 described above, the apparent elevation angle range may be determined to be a first angle range. The first angle range may be higher than a second angle range. As described above, the first angle range and the second angle range may respectively correspond to ranges obtained by bisecting the apparent elevation angle range. Accordingly, a new apparent elevation angle range (e.g., an apparent elevation angle range after change) may be a range corresponding to half of the previous apparent elevation angle range (e.g., the apparent elevation angle range before the change). A maximum elevation angle 710 in the new apparent elevation angle range may be determined to be the same elevation angle as a maximum elevation angle in the previous apparent elevation angle range. A minimum elevation angle 730 in the new apparent elevation angle range may be determined to be the same elevation angle as the median elevation angle in the previous apparent elevation angle range. A median elevation angle 720 of the new apparent elevation angle range may be determined to be an elevation angle having a median value between the maximum elevation angle 710 in the new apparent elevation angle range and the minimum elevation angle 730 in the new apparent elevation angle range.

According to an example embodiment, the processor may determine an apparent elevation angle through a bisection search. The bisection search may include, for example, an algorithm for bisecting an apparent elevation angle range and repeatedly updating the apparent elevation angle range to a range in which a true elevation angle is present in the bisected ranges until the apparent elevation angle range becomes less than or equal to (or within) a tolerance. For example, while the apparent elevation angle range exceeds (or out of) the tolerance, the processor may repeatedly update the apparent elevation angle range as described above with reference to FIGS. 6 and 7. That is, the processor may repeat the updating of the apparent elevation angle range until the apparent elevation angle range is within the tolerance. For example, in response to the apparent elevation angle range exceeding the tolerance, the processor may update the apparent elevation angle range to one of a first angle range and a second angle range of the apparent elevation angle range. As described above, the first angle range and the second angle range may be obtained by bisecting the apparent elevation angle range. In response to the updated apparent elevation angle range still exceeding the tolerance, the processor may update the apparent elevation angle range to one of a third angle range and a fourth angle range of the updated apparent elevation angle range. The third angle range and the fourth angle range may be obtained by bisecting the updated apparent elevation angle range. The third angle range may be higher than the fourth angle range. As such, in response to the updated apparent elevation angle range exceeding the tolerance, the processor may repeat the updating of the updated apparent elevation angle range to a bisected range. The processor may perform the bisection search for an apparent elevation angle through this repeated updating operation described above. As described above with reference to FIG. 5, in response to the updated apparent elevation angle range being less than or equal to the tolerance, the bisection search may be terminated. In this case, the processor may determine an apparent elevation angle to be a median elevation angle of the updated apparent elevation angle range.

The examples described herein may be implemented using hardware components, software components and/or combinations thereof. A processing device may be implemented using one or more general-purpose or special purpose computers, such as, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an OS and one or more software applications that run on the OS. The processing device also may access, store, manipulate, process, and create data in response to execution of the software. For the purpose of simplicity, the description of a processing device is used as singular; however, one skilled in the art will appreciate that a processing device may include multiple processing elements and multiple types of processing elements. For example, a processing device may include multiple processors or a processor and a controller. In addition, different processing configurations are possible, such as, parallel processors.

The software may include a computer program, a piece of code, instructions, or some combination thereof, to independently or collectively instruct or configure the processing device to operate as desired. The software and/or data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described examples may be recorded in non-transitory computer-readable media including program instructions to implement various operations of the above-described examples. The media may also include, alone or in combination with the program instructions, data files, data structures, and the like. The program instructions recorded in the media may be specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described hardware devices may be configured to act as one or more software modules in order to perform the operations of the above-described examples, or vice versa.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

What is claimed is:

1. A processor-implemented method of determining an apparent elevation angle, the method comprising:
determining a distance between a ground station and a flight vehicle and a true elevation angle corresponding to a direction from the ground station toward the flight vehicle;
determining a maximum elevation angle error;
determining an apparent elevation angle range relative to the true elevation angle, based on the maximum elevation angle error;
updating the apparent elevation angle range by comparing the true elevation angle and an elevation angle estimated from a median elevation angle of the apparent elevation angle range based on refractive indices of altitudes between the ground station and the flight vehicle; and
determining the apparent elevation angle, in response to the apparent elevation angle range being within a tolerance.

2. The method of claim 1, wherein the updating of the apparent elevation angle range comprises:
changing the apparent elevation angle range to one of a first angle range and a second angle range, relative to the median elevation angle of the apparent elevation angle range, based on a result of comparing the true elevation angle and the elevation angle estimated from the median elevation angle of the apparent elevation angle range.

3. The method of claim 2, wherein the changing of the apparent elevation angle range comprises:
determining the apparent elevation angle range to be the first angle range in response to the elevation angle estimated from the median elevation angle of the apparent elevation angle range being less than the true elevation angle, and determining the apparent elevation angle range to be the second angle range in response to the elevation angle estimated from the median elevation angle of the apparent elevation angle range being greater than the true elevation angle.

4. The method of claim 3, wherein the first angle range is higher than the second angle range.

5. The method of claim 1, wherein the updating of the apparent elevation angle range comprises:
determining the apparent elevation angle to be the median elevation angle of the apparent elevation angle range, in response to the elevation angle estimated from the median elevation angle of the apparent elevation angle range being equal to the true elevation angle.

6. The method of claim 1, wherein the updating of the apparent elevation angle range comprises:
repeatedly updating the apparent elevation angle range while the apparent elevation angle range is out of the tolerance.

7. The method of claim 1, further comprising:
orienting an antenna of the ground station toward the determined apparent elevation angle.

8. The method of claim 1, wherein the determining of the maximum elevation angle error comprises:
determining the maximum elevation angle error, using the true elevation angle and a direction toward a position at which a radio wave transmitted by the ground station at the true elevation angle is propagated to the same altitude as the flight vehicle based on the refractive indices of the altitudes between the ground station and the flight vehicle.

9. The method of claim 8, wherein the determining of the maximum elevation angle error comprises:
determining a constant of Snell's law based on the true elevation angle;
determining a bending angle by numerical integration based on the refractive indices of the altitudes between the ground station and the flight vehicle and the constant of Snell's law;
determining a receiving angle of the flight vehicle based on the constant of Snell's law;
determining a spherical angle based on the true elevation angle, the bending angle, and the receiving angle of the flight vehicle; and
determining the direction toward the position at which the radio wave transmitted by the ground station at the true elevation angle is propagated to the same altitude as the flight vehicle, based on the spherical angle.

10. The method of claim 1, wherein the updating of the apparent elevation angle range comprises:
determining a constant of Snell's law based on the median elevation angle of the apparent elevation angle range;
determining a bending angle by numerical integration based on the refractive indices of the altitudes between the ground station and the flight vehicle and the constant of Snell's law;
determining a receiving angle of the flight vehicle based on the constant of Snell's law;
determining a spherical angle based on the median elevation angle of the apparent elevation angle range, the bending angle, and the receiving angle of the flight vehicle; and
determining the elevation angle estimated from the median elevation angle of the apparent elevation angle range, based on the spherical angle.

11. A non-transitory computer-readable storage medium storing instructions that, when executed by a processor, cause the processor to perform the method of claim 1.

12. An apparatus for determining an apparent elevation angle, the apparatus comprising:
a processor configured to: determine a distance between a ground station and an altitude of a flight vehicle and a true elevation angle corresponding to a direction from the ground station toward the flight vehicle; determine a maximum elevation angle error; determine an apparent elevation angle range relative to the true elevation angle based on the maximum elevation angle error; update the apparent elevation angle range by comparing the true elevation angle and an elevation angle estimated from a median elevation angle of the apparent elevation angle range based on refractive indices of altitudes between the ground station and the flight vehicle; and determine the apparent elevation angle in response to the apparent elevation angle range being within a tolerance.

13. The apparatus of claim 12, wherein the processor is configured to:
change the apparent elevation angle range to one of a first angle range and a second angle range, relative to the median elevation angle of the apparent elevation angle range, based on a result of comparing the true elevation angle and the elevation angle estimated from the median elevation angle of the apparent elevation angle range.

14. The apparatus of claim 13, wherein the processor is configured to:
determine the apparent elevation angle range to be the first angle range in response to the elevation angle estimated from the median elevation angle of the apparent elevation angle range being less than the true elevation angle, and determine the apparent elevation angle range to be the second angle range in response to the elevation angle estimated from the median elevation angle of the apparent elevation angle range being greater than the true elevation angle.

15. The apparatus of claim 14, wherein the first angle range is higher than the second angle range.

16. The apparatus of claim 12, wherein the processor is configured to:
determine the apparent elevation angle to be the median elevation angle of the apparent elevation angle range, in response to the elevation angle estimated from the median elevation angle of the apparent elevation angle range being equal to the true elevation angle.

17. The apparatus of claim 12, wherein the processor is configured to:
repeatedly update the apparent elevation angle range while the apparent elevation angle range is out of the tolerance.

18. The apparatus of claim 12, wherein the processor is configured to:
orient an antenna of the ground station toward the determined apparent elevation angle, via a drive portion.

19. The apparatus of claim 12, wherein the processor is configured to:
determine the maximum elevation angle error, using the true elevation angle and a direction toward a position at which a radio wave transmitted by the ground station at the true elevation angle is propagated to the same altitude as the flight vehicle based on the refractive indices of the altitudes between the ground station and the flight vehicle.

20. The apparatus of claim 19, wherein the processor is configured to:
determine a constant of Snell's law based on the true elevation angle; determine a bending angle by numerical integration based on the refractive indices of the altitudes between the ground station and the flight vehicle and the constant of Snell's law; determine a receiving angle of the flight vehicle based on the constant of Snell's law; determine a spherical angle based on the true elevation angle, the bending angle, and the receiving angle of the flight vehicle; and determine the direction toward the position at which the radio wave transmitted by the ground station at the true elevation angle is propagated to the same altitude as the flight vehicle, based on the spherical angle.
